(19) United States
(12) Patent Application Publication
(10) Pub. No.: US 2019/0077187 A1
(43) Pub. Date: Mar. 14, 2019

(54) PAINT CAN GROOVE PROTECTOR

(71) Applicant: Frans X. VAN BUUREN, Calgary (CA)

(72) Inventor: Frans X. VAN BUUREN, Calgary (CA)

(21) Appl. No.: 16/129,534

(22) Filed: Sep. 12, 2018

Related U.S. Application Data
(60) Provisional application No. 62/606,163, filed on Sep. 12, 2017.

(51) Int. Cl. B44D 3/12

(52) U.S. Cl. CPC B44D 3/128

(57) ABSTRACT

A resilient, flexible, ring-shaped paint can groove protector is provided having a plug portion configured to fit within a lid-receiving groove of a paint can. First and second sealing faces of the protector seal against first and second walls of the groove to mitigate the accumulation of paint and debris therein. An outer flange portion can extend radially outwards from the plug portion to sealingly engage with the shoulder and/or an adjacent third wall of the paint can. A skirt can depend from the outer flange portion to engage the tubular wall of the paint can. The protector can be made of an elastomeric material that is resistant to bonding with paint, such that paint can easily be washed or peeled off. The protector can be re-used many times without its effectiveness being compromised by dried paint accumulating thereon.

### CROSS-REFERENCE TO RELATED APPLICATIONS

This application claims the benefit of U.S. Provisional Patent application Ser. No. 62/606,163, filed Sep. 12, 2018, the entirety of which is incorporated herein by reference.

### FIELD

Embodiments herein relate to accessories for paint cans, and more particularly to a plug for protecting the lid-receiving groove of a paint can.

### BACKGROUND

Paint cans are typically constructed having a lid-receiving groove located at an upper end of the can for accommodating a paint can lid. To secure the lid to the paint can, an annular protrusion of the lid can be aligned with the lid groove. The lid can then be pushed down such that the annular protrusion snugly engages with the groove, thus retaining the lid on the paint can and sealing the contents of the can such that they do not escape or dry up due to exposure to air.

In normal use during painting, the lid is removed from the can and the user dips a paint brush into the can to collect paint on the brush, then brushes the brush against an inner lip of the paint can to remove excess paint therefrom. Alternatively, the user can pour paint from the can into another container such as a tray. During both operations, paint can collect in the lid-receiving groove of the paint can. Such accumulation of paint in the lid groove is problematic, as the collected paint can be expelled due to the pressure created when the lid is forced back into the groove. Additionally, if the paint is allowed to dry within the groove, it can interfere with the engagement between the lid and groove, resulting in a poor seal or preventing the lid from engaging with the groove altogether.

Prior art solutions for protecting the groove from the accumulation of paint and debris includes the use of an annular groove protector that overlays the groove of the paint can to prevent paint from entering into the groove. Some devices clip onto the inner and outer lips of the paint can to secure the device thereto and/or create a seal therewith. Other protectors incorporate a gasket in combination with an annular groove protector that seals against the inner lip of the paint can.

Existing devices for protecting the lid-receiving grooves of paint cans are problematic as they are relatively complicated, comprising multiple components, must be replaced over time due to the accumulation of paint thereon thus interfering with proper fit with the paint can, and sometimes fail to adequately seal with the paint can, which allows paint to bypass the protector and enter into the groove. Most groove protectors are also made of a substantially rigid material, such as hard plastics, for example to clip onto the outer and/or inner lips of the paint can. Such rigid protectors are harder to store and ship. Existing groove protectors can also present edges or other structures that can catch on a paintbrush or other object, for example when a user is brushing excess paint off of the paintbrush onto the inner rim of the can and/or protector, potentially displacing the protector from engagement with the can.

### SUMMARY

Generally, a resilient, flexible, ring-shaped paint can groove protector is provided having a plug portion configured to fit within a lid-receiving groove of a paint can, such that first and second sealing faces of the protector seal against first and second walls of the groove to mitigate the accumulation of paint and debris therein. For paint cans with shoulders adjacent to the groove, the protector can further comprise an outer flange portion extending radially outwards from the plug portion to sealingly engage with the shoulder and/or an adjacent third wall. In embodiments, a skirt can depend from the outer flange portion to engage the tubular wall of the paint can and further mitigate paint and debris from collecting on the shoulder of the groove of the can. The protector can be made of an elastomeric material that is resistant to bonding with paint, such that paint can easily be washed or peeled off of the protector. In this manner, the protector can be re-used many times without its effectiveness being compromised by dried paint accumulating thereon.

In a broad aspect, a paint can groove protector is provided for mitigating accumulation of paint and debris in a lid-receiving groove of a paint can, the paint can having a tubular wall, a closed bottom, and an open top, the groove located between an inner lip and an outer lip of the top of the paint can and having a first wall depending from the inner lip, a second wall, and a groove width, and wherein a shoulder is located between a third wall depending from the outer lip and the second wall, the groove protector can comprise a resilient, flexible ring-shaped plug portion shaped to correspond with the groove and having a thickness at least equal to the groove width for sealing against the inner wall and outer wall of the groove.

In an embodiment, the resilient ring further comprises an outer flange portion having a flange width and extending radially outwards from the plug portion and configured to seal against at least the third wall of the groove.

In an embodiment, a shape of the outer flange portion substantially corresponds with the third wall and the shoulder.

In an embodiment, a skirt depends from an outer edge of the outer flange portion for hanging over the outer lip and engaging with the tubular wall of the paint can.

In an embodiment, the skirt can be manipulated between an upward and a downward position.

In an embodiment, an unstretched diameter of the skirt is slightly smaller than a diameter of the tubular wall of the paint can.

In an embodiment, the thickness of the plug portion is greater than the groove width to provide an interference fit therebetween.

In an embodiment, the flange width of the outer flange portion is greater than a distance between the first and third walls to provide an interference fit therebetween.

In an embodiment, an upper face of the groove protector is configured to sit substantially flush with at least the inner lip of the paint can.

In an embodiment, the groove protector is made of an elastomeric material that is resistant to bonding with paint.

In an embodiment, the groove protector is made of silicone.

In another broad aspect, a method for using a paint can groove protector can comprise aligning the groove protector with a lid-receiving groove of a paint can; pressing the groove protector into the lid groove; removing the groove protector from the lid groove; and manipulating the groove protector to peel off any paint accumulated thereon.

In an embodiment, the method for using a paint can groove protector can further comprise manipulating a skirt of the groove protector to an upward position before pressing the groove protector, and manipulating the skirt to a downward position after pressing the groove protector.

In an embodiment, the method for using a paint can groove protector can further comprise stretching a skirt of the groove protector around a tubular wall of the paint can.

### BRIEF DESCRIPTION OF THE DRAWINGS

FIG. 1 is a cross-sectional elevation view of a lid-receiving groove of a paint can;

FIG. 2A is an isometric view of an embodiment of a groove protector having a plug portion, outer flange portion, and inner flange portion;

FIG. 2B is a bottom plan view of the groove protector of FIG. 2A;

FIG. 2C is an cross-sectional elevation view of the groove protector of FIGS. 2A and 2B along line A-A;

FIG. 3A is a close-up cross-sectional elevation view of another embodiment of a groove protector having an annular protrusion extending from an outer flange portion;

FIG. 3B is a close-up cross-sectional elevation view of another embodiment of a groove protector having an outer flange portion without an annular protrusion;

FIG. 4 is a close-up cross-sectional elevation view of the groove protector of FIG. 3 inserted into the lid-receiving groove of a paint can;

FIG. 5 is a close-up cross-sectional elevation view of another embodiment of a groove protector having a skirt depending from the outer flange portion; and

FIG. 6 is a close-up cross-sectional elevational view of the groove protector of FIG. 5 inserted into the lid-receiving groove of a paint can with its skirt engaged around the tubular wall of the paint can.

### DESCRIPTION

According to embodiments herein, a groove protector 20 is provided for use with a paint can 2 to mitigate the accumulation of paint and other debris in a lid-receiving groove 4 of the paint can 2.

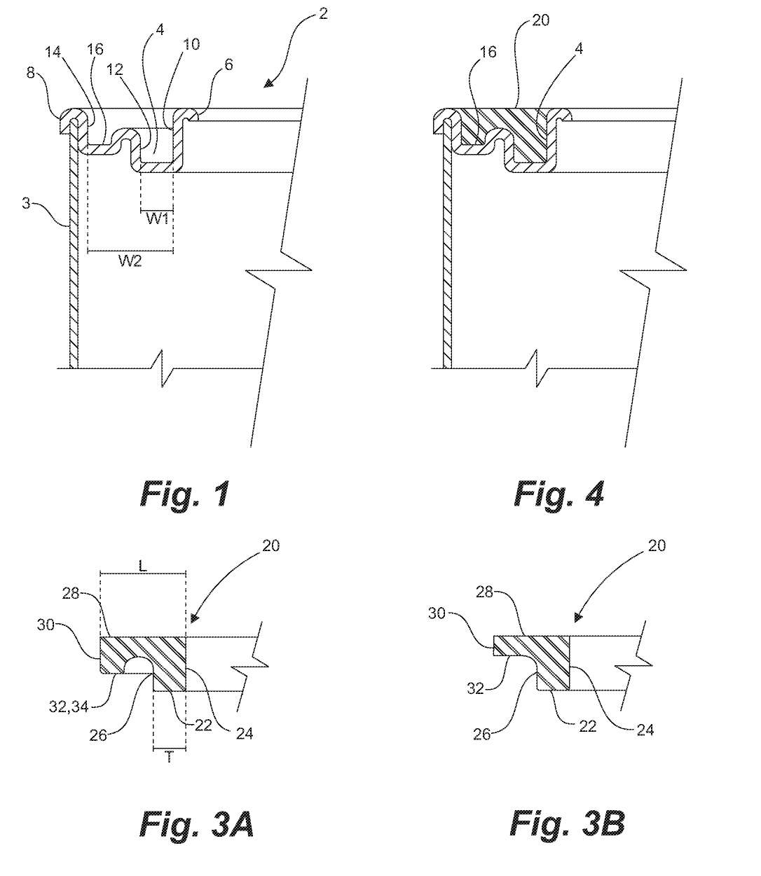

As shown in FIG. 1, a paint can 2 typically comprises a tubular wall 3, a closed bottom, an open top, and a lid-receiving groove 4 located between an inner lip 6 and an outer lip 8 at the top of the can 2. The groove 4 is defined by an inner first wall 10 depending from the inner lip 6, and a medial second wall 12 depending from a shoulder 16 and adjoining the first wall 10. Shoulder 16 is located between an outer third wall 14, depending from the outer lip 8, and the second wall 12 to accommodate a peripheral edge of the paint can lid (not shown).

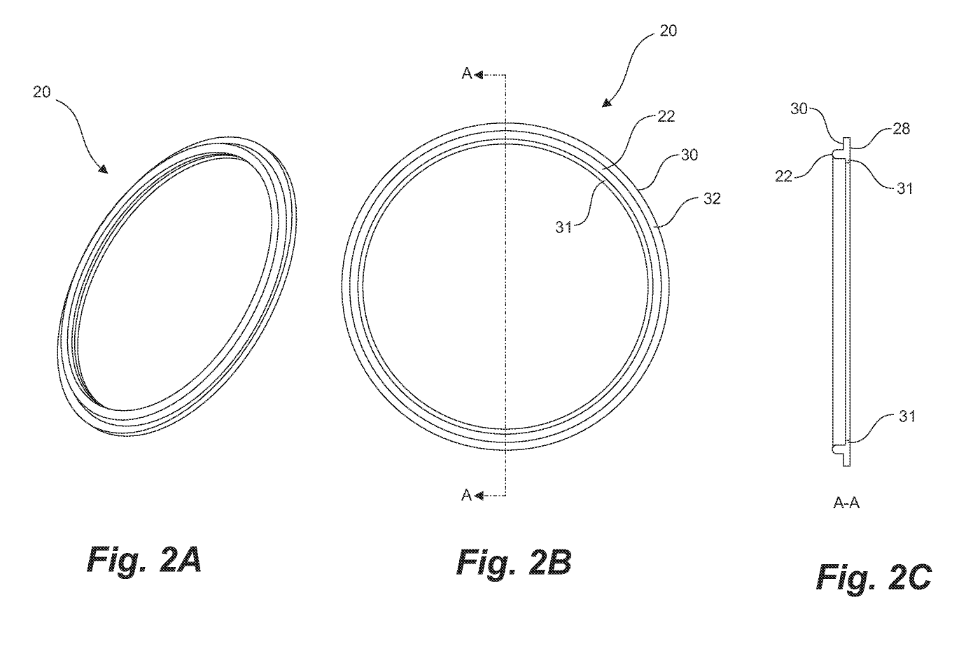

Turning now to FIGS. 2A-6, the groove protector 20 is a resilient, flexible, ring-shaped member having a plug portion 22 that is configured to sealably fit within the lid-receiving groove 4 of a paint can 2 to substantially prevent paint and debris from entering into the groove 4. More specifically, when the protector 20 is inserted into the groove 4, a first sealing face 24 and second sealing face 26 of the protector 20 contact the first wall 10 and second wall 12 of the groove 4, respectively. When the protector 20 is pressed into the groove 4, the first and second sealing faces 24,26 are correspondingly pressed into the first and second walls 10,12 in a sealing engagement therewith. In embodiments, as best shown in FIGS. 1, 3A, and 4, the shape of the plug portion 22 can substantially correspond with the shape of the groove 4, but have a radial thickness T slightly greater than the width of the groove 4 so as to provide an interference fit between the plug portion 22 and groove 4 when the protector is pressed therein. It is not imperative that the plug portion 22 completely fill the groove 4, so long as that respective sealing engagements between the first and second sealing faces 24,26 and the first and second walls 10,12 are obtained. In embodiments, plug portion 22 can be configured to leave a space between the bottom of the plug portion 22 and the bottom of the groove 4 when inserted therein to mitigate the buildup of air pressure therein.

With reference to FIGS. 2A-4, in embodiments, the groove protector 20 can further comprise an outer flange portion 30 that generally extends radially outwards from the plug portion 22 and is configured to sealably engage with the third wall 14 and/or the shoulder 16 to mitigate the accumulation of paint and debris in/on the shoulder 16. In embodiments, the shape of the outer flange portion 30 can substantially correspond with the shape of the shoulder 16 to provide a closer fit between the two and thereby more effectively mitigate the accumulation of paint. For example, as shown in FIGS. 3A and 4, the outer flange portion 30 has an annular protrusion 34 extending downward from the lower face 32 of the outer flange 30 so as to correspond with the shape of the shoulder 16 of the paint can 2. In other embodiments, the lower face 32 of the outer flange portion 30 can be substantially flat, as shown in FIGS. 2A-2C and 3B. As with the plug portion 22, with reference to FIGS. 1 and 3A, a flange width L of the outer flange portion 30 can be slightly greater than the distance W2 between the first and third walls 10,14 to provide an interference fit between the groove protector 20 and the walls 10,14.

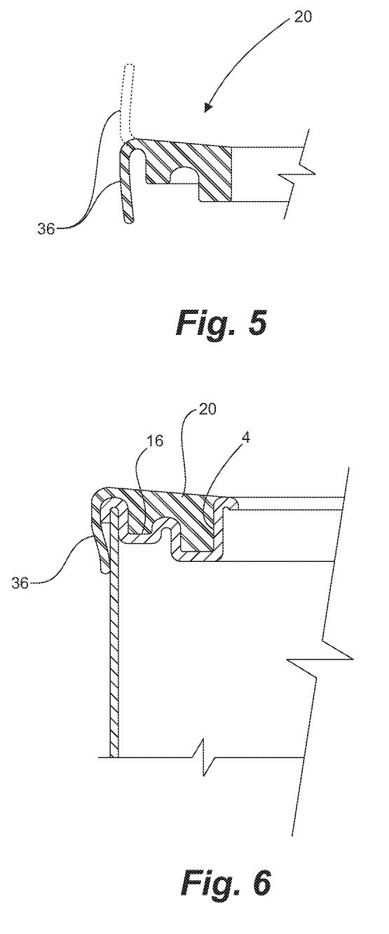

With reference to FIG. 5, in an alternative embodiment, a skirt 36 can depend from the outer edge of the outer flange portion 30 so as to hang over the outer lip 8 of the can 2 to further mitigate accumulation of paint in the groove 4 or shoulder 16. In an unstretched state, the diameter of the skirt 36 can be about equal to, or less than, the diameter of the tubular wall 3 of the can 2, such that when the skirt 36 is stretched over the outside of the can 2, it snugly engages the tubular wall 3 to more effectively prevent paint from entering into the groove 4 or shoulder 16. The skirt 36 can be of any length suitable to effectively mitigate the accumulation of paint in in the groove 4 and/or shoulder 16. In the embodiment depicted in FIG. 5, the length of the skirt is about equal to the height of the plug portion 22.

As best shown in FIG. 4, in embodiments, the groove protector 20 can be configured such that its upper face 28 is generally flat and sits substantially flush with the inner and outer lips 6,8 of the can 2 when the protector 20 is pressed into sealing engagement with the groove 4. Such a configuration reduces the likelihood that a paintbrush or other object will catch the groove protector 20 and displace it from its sealing engagement with the groove 4. Referring now to FIG. 6, for embodiments having a skirt 36, the upper face 28 of the protector 20 can be configured to sit flush with the inner lip 6. As users typically brush a paintbrush on the inner lip of the can 2 to remove excess paint therefrom, and skirt 36 will be engaged with the tubular wall 3 of the can 2, having the upper face 28 sit flush with only the inner lip 6 would still function to reduce the likelihood of the groove protector 20 being displaced from the groove 4. As one of skill in the art would understand, the groove protector 20 can be manufactured in different shapes so as to sit substantially flush with the inner and outer lips 6,8, or at least the inner lip 6, of a variety of cans having grooves 4 of various shapes. For example, in some embodiments, as shown in FIGS. 2A-2C, the groove protector 20 can further comprise an inner flange 31 extending radially inwards from the plug portion 22 to fill the space created by an inner shoulder of a paint can (not shown), so as to mitigate accumulation of paint and debris on/in the inner shoulder and such that the protector 20 can sit substantially flush with the inner and outer lips 6,8, and avoid presenting edges or other structures that may catch on a paint brush.

Preferably, the groove protector 20 is made of a resilient, flexible material, such as a relatively soft elastomeric material, that is resistant to bonding with paint. In the depicted embodiments, the protector 20 is made of silicone.

In use, the plug portion 22 of the protector 20 is aligned with the groove 4 and inserted therein. The protector 20 is then pressed using downwards force into the groove 4 to create a sealing engagement between the first and second sealing faces 24,26 of the protector 20 and the first and second walls 10,12 of the groove 4, respectively. In embodiments of the protector 20 having the outer flange portion 30, the pressing also creates a sealing engagement between the outer flange portion 30 and the third wall 14 and/or shoulder 16.

Turning now to FIG. 6, for embodiments of the protector 20 having a skirt 36, the skirt 36 can be stretched over the tubular wall 3 of the paint can 2 as the plug portion 22 is inserted into the groove 4. Alternatively, in embodiments wherein the protector 20 is made of a sufficiently flexible material such as silicone, the skirt 36 can be flipped to an upward position such that it extends upward and axially away from the can 2 as the plug portion 22 is inserted into the groove 4. Once the protector 20 has been pressed into the groove 4, the skirt 36 can be flipped to a downward position such that the skirt 36 engages the tubular wall 3 of the can 2. This allows for easier alignment of the plug portion 22 with the groove 4 and more convenient installation of the protector 2.

Once installed on a paint can 2, the user can use the can 2 as one normally would, such as dipping a paintbrush into the can and brushing the brush on the inner lip 6 of the can 2 to remove excess paint, or pouring paint from the can 2 into another container. The respective seals formed between the first and second sealing faces 24,26 and the first and second walls 10,12, and between the outer flange portion 30 and the third wall 14 and/or shoulder 16, mitigate the accumulation of paint and debris in the groove 4 and on the shoulder 16. When the user has finished painting, the protector 20 can be removed from the groove 4 and washed to remove any paint that has collected thereon. To remove any paint that has dried on the protector 20, the protector 20 can manipulated such as by twisting, compressing, stretching, and/or shaking to peel off the dried paint. As accumulated paint can readily be removed from the protector 20, the ability of the protector 20 to effectively seal with a groove 4 of a paint can in subsequent painting projects is substantially preserved.

Embodiments of the present groove protector 20 are advantageous over existing groove protectors as the present groove protector 20 provides a compact, simple, one-piece design that seals with the groove 4 of a paint can 2 as opposed to simply overlaying the groove 4 or clipping to the inner and/or outer lips 6,8. The protector 20 also does not present edges for the paint brush or other objects to catch on and inadvertently displace the protector 20 from the groove 4. The groove protector 20 is also durable and can be reused many times, as paint collected thereon can be easily removed from the protector 20. In this manner, the effectiveness of the protector 20 is not compromised by dried paint accumulating thereon.

We claim:

1. A paint can groove protector for mitigating accumulation of paint and debris in a lid-receiving groove of a paint can, the paint can having a tubular wall, a closed bottom, and an open top, the groove located between an inner lip and an outer lip of the top of the paint can and having a first wall depending from the inner lip, a second wall, and a groove width, and wherein a shoulder is located between a third wall depending from the outer lip and the second wall, the groove protector comprising:
a resilient, flexible ring-shaped plug portion shaped to correspond with the groove and having a thickness at least equal to the groove width for sealing against the inner wall and outer wall of the groove.

2. The groove protector of claim 1, wherein the resilient ring further comprises an outer flange portion having a flange width and extending radially outwards from the plug portion and configured to seal against at least the third wall of the groove.

3. The groove protector of claim 2, wherein a shape of the outer flange portion substantially corresponds with the third wall and the shoulder.

4. The groove protector of claim 2, wherein a skirt depends from an outer edge of the outer flange portion for hanging over the outer lip and engaging with the tubular wall of the paint can.

5. The groove protector of claim 4, wherein the skirt can be manipulated between an upward and a downward position.

6. The groove protector of claim 4, wherein an unstretched diameter of the skirt is slightly smaller than a diameter of the tubular wall of the paint can.

7. The groove protector of claim 1, wherein the thickness of the plug portion is greater than the groove width to provide an interference fit therebetween.

8. The groove protector of claim 2, wherein the flange width of the outer flange portion is greater than a distance between the first and third walls to provide an interference fit therebetween.

9. The groove protector of claim 1, wherein an upper face of the groove protector is configured to sit substantially flush with at least the inner lip of the paint can.

10. The groove protector of claim 1, wherein the groove protector is made of an elastomeric material that is resistant to bonding with paint.

11. The groove protector of claim 10, wherein the groove protector is made of silicone.

12. A method for using a paint can groove protector, comprising:
aligning the groove protector with a lid-receiving groove of a paint can;
pressing the groove protector into the lid groove;
removing the groove protector from the lid groove; and
manipulating the groove protector to peel off any paint accumulated thereon.

13. The method of claim 12, further comprising manipulating a skirt of the groove protector to an upward position before pressing the groove protector, and manipulating the skirt to a downward position after pressing the groove protector.

14. The method of claim 12, further comprising the step of stretching a skirt of the groove protector around a tubular wall of the paint can.
